(19) United States
(12) Patent Application Publication
(10) Pub. No.: US 2009/0053562 A1
(43) Pub. Date: Feb. 26, 2009

(54) METHOD FOR REFORMING DIESEL FUEL AND REACTOR FOR THIS PURPOSE

(76) Inventors: Axel Maurer, Augsburg (DE); Klaus Wanninger, Kolbermoor (DE); Herbert Wancura, Seiersberg (AT)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/094,913

(22) PCT Filed: Nov. 11, 2006
(86) PCT No.: PCT/EP2006/011307

§ 371 Date: Sep. 9, 2008

(30) Foreign Application Priority Data
Nov. 25, 2005 (DE) 10 2005 056 363.5

(51) Int. Cl. H01M 8/04; C10J 1/00

(52) U.S. Cl. 429/12; 48/219; 48/144

(57) ABSTRACT

The invention relates to a method and a device for reforming diesel fuel into a product gas containing H₂ and CO, the diesel fuel being mixed in a first premixing stage with an O₂-containing gas mixture and subsequently the thus obtained mixture being mixed in a second premixing stage with an O₂-containing gas mixture and also with an exhaust gas mixture and subsequently this mixture being subjected to a hydrocarbon oxidation in a reactor with a catalyst.

The present invention relates to a method for converting diesel fuel into a product gas containing H₂ and CO and also to a corresponding reactor.

In particular fuel cells which are operated in a stationary manner are supplied nowadays and in the foreseeable future most economically with hydrogen, said hydrogen being produced by reforming carbon-containing energy carriers. For example natural gas is possible for reforming since this is technically the simplest to reform. If natural gas is not available in situ, other energy carriers, such as for example propane/butane or benzene, can also be resorted to.

It is hereby technically particularly demanding to reform media which constitute a mixture containing hydrocarbon compounds, in particular if this is mixed with aromatics which are difficult to evaporate.

Diesel for example represents such a liquid mixture comprising hydrocarbon compounds and also aromatics which are difficult to evaporate.

For the above-described reforming of hydrocarbons, in particular diesel fuels, various methods in the state of the art have become known for this purpose.

On the one hand, steam reforming can be mentioned here, i.e. reforming with water, the second possibility concerns so-called particle oxidation (POX) and the third possibility is so-called autothermal reforming, i.e. reforming with air and water.

However, steam reforming is not suitable for mobile application because of its high water consumption. The partial oxidation (POX) of diesel fuel is unfavourable because of the risk of formation of carbon black. Autothermal reforming therefore represents the only possibility of reforming diesel for mobile application with the current state of knowledge. For autothermal reforming, e.g. of diesel, the operation thereby takes place normally with an air ratio of 0.3 to 0.4 and an S/C ratio (steam to carbon) of 1.5 to 2.5. However, the S/C ratio is precisely problematic in particular for mobile application of the method. Large water quantities must be carried also in the vehicle for this purpose and be condensed out, which would imply a high technological processing, financial and spatial expenditure.

Starting herefrom, it is therefore the object of the present invention to indicate a method and also a reactor for reforming diesel fuel, which can be operated economically and with low complexity, it being required in particular that the process must be able to be implemented if possible without liquid water.

The object of the present invention is achieved by the features of patent claim 1 with respect to the method and by the features of patent claim 15 with respect to the reactor. The sub-claims reveal advantageous developments.

According to the invention, it is hence proposed to subject diesel fuels (educts) before the hydrocarbon oxidation in the reactor to a specific two-stage premixing. It is thereby essential according to the invention that in the second premixing stage the educts are mixed not with water, as known per se to date in the state of the art, but that, in the second premixing stage, a gas containing oxygen and an exhaust gas mixture containing H₂O, N₂ and CO₂ is added. In the case of the method according to the invention, it is therefore no longer necessary to add liquid water, which has hence advantageous effects on the conduct of the method, namely such that now a simple method is possible since the weight of the total plant can be reduced, which leads at the same time also to low costs. In the case of the method according to the invention, it must be stressed in addition that, despite the addition of water in the form of an H₂O, N₂ and CO₂ exhaust gas mixture, it was established with the obtained product gas that only small quantities of higher hydrocarbons are produced in the reforming process according to the invention in comparison with reforming processes in the prior art, in which the operation takes place with large quantities of liquid water.

In the case of the method according to the invention, it is thereby preferred if, during the second premixing stage, the waste gas mixture containing H₂O, N₂ and CO₂ is the exhaust gas from a diesel combustion. This confers the crucial advantage that low costs are associated herewith since the operation can take place with simple exhaust gases, e.g. with the exhaust gas of an engine. The exhaust gas mixture which is used in the second premixing stage can thereby preferably contain 10 to 15% by volume CO₂, 10 to 13% by volume water, 0 to 5% by volume O₂ and 73 to 75% by volume nitrogen. It is furthermore favourable if the oxygen provided for the second premixing stage is supplied in the form of air, particularly preferred in the form of ambient air. This also applies to the gas containing oxygen and supplied in the first premixing stage, in which air is used likewise preferably, particularly preferred ambient air.

It has proved useful with the method according to the invention if the gas mixture provided for the first premixing stage is added with an air ratio “lambda” between 0.28 and 0.43, preferably between 0.31 and 0.41. The air ratio “lambda” is the actually supplied oxygen quantity divided by the oxygen quantity which is required for total oxidation. The gas mixture for the second premixing stage is added with an S/C ratio (=material quantity of water vapour in the supplied gas mixture/material quantity of carbon atoms in the fuel educt) between 0.1 and 0.9, preferably between 0.25 and 0.5.

Further favourable method conditions for the method according to the invention with respect to the temperature are if the educts have, before mixing in the first stage, a supply temperature of 10 to 70° C., preferably 40 to 60° C. With respect to the gas mixture for the first premixing stage, it has proved to be advantageous if the temperature is 0 to 50° C., preferably 15 to 25° C., In the case of the temperature for the second premixing stage, 350 to 600° C., in particular 400 to 500° C., are favourable.

As is known per se in the state of the art, 850 to 1000° C. and 0 to 10 bar excess pressure are required for implementation of the hydrocarbon oxidation in the reactor.

The invention relates furthermore to a reactor for implementing a method as described above.

The reactor according to the invention is thereby constructed such that it has a two-fluid nozzle which produces a first premixing stage and a second premixing stage, a reactor chamber in which the hydrocarbon oxidation then takes place, being disposed after the two-fluid nozzle.

Developments of the reactor according to the invention are explained subsequently.

The supply of educts can be effected in a simplified manner, for example by means of a tubular inflow pipe.

It is particularly simple with respect to production technology that the inflow pipe of the educts has one or more lateral openings with which the O₂-containing first gas mixture of the first premixing stage is introduced.

As a result, the inflow pipe which is provided with a lateral opening becomes the “first premixing stage”. At the end of this first premixing stage, a nozzle is preferably provided which is orientated towards the second premixing stage which is located at the beginning of the reactor chamber.

The educt, preferably diesel, is therefore introduced by nozzle into the reactor by means of the two-fluid nozzle. A special embodiment of the reactor which is configured as a pressure vessel and is manufactured for example from a stainless steel is dealt with again further on. The second premixing stage adjoining the beginning of the reactor chamber preferably has a circumferential chamber or an annular chamber around itself which serves for distribution of the gas mixture for the second premixing stage (which contains O₂ and also a mixture of CO₂, N₂ and H₂O). The surrounding circumferential chamber hereby preferably has radially distributed mixing nozzles which enable uniform inflow of the second gas mixture into the second premixing stage. It is hereby advantageous that (in the sense of a uniform distribution of the second gas mixture into the second mixing stage) a tangential supply is provided for the second gas mixture containing O₂ and also H₂O, CO₂ and N₂.

In the adjacent reactor chamber, preferably a cladding made of ceramic material (preferably aluminium oxide) which has preferably a tubular configuration is provided. The reactor chamber is hereby preferably manufactured as a pressure housing, a two-shell configuration being of advantage here. In the first shell, the ceramic pipe for example is provided, around it a stainless steel housing is constructed. This stainless steel housing or the reactor chamber can be retained by at least one flange.

On the side of the reactor chamber which is orientated away from the second premixing stage, a catalyst is preferably provided, for example a noble metal catalyst which contains a metallic or ceramic carrier.

Optionally, various elements can be provided subsequent to the reactor chamber or the catalyst, for example CO shift/CO fine cleaning etc. Gas purification is not absolutely necessary for example for high temperature fuel cells.

The invention is explained subsequently in more detail with reference to 6 Figures. There are shown:

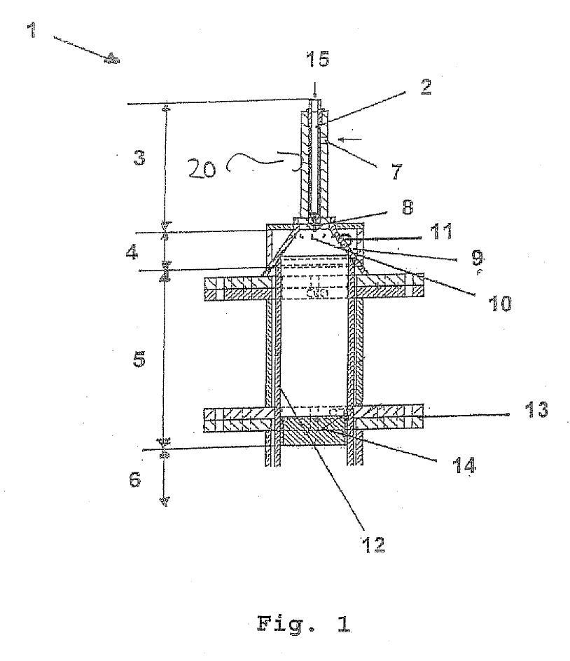

FIG. 1 a cross section through the construction of a reactor according to the invention,

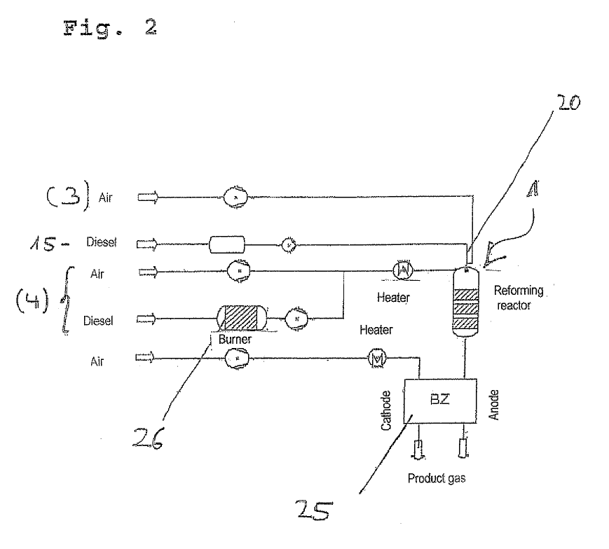

FIG. 2 a flow diagram for a preferred embodiment of the method,

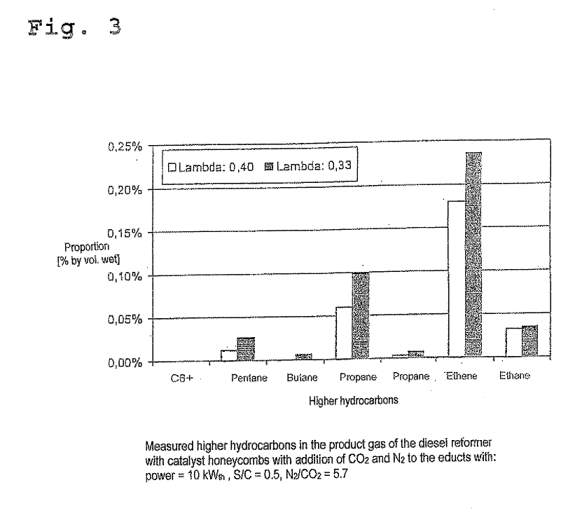

FIG. 3 the proportion of higher hydrocarbons in the product gas,

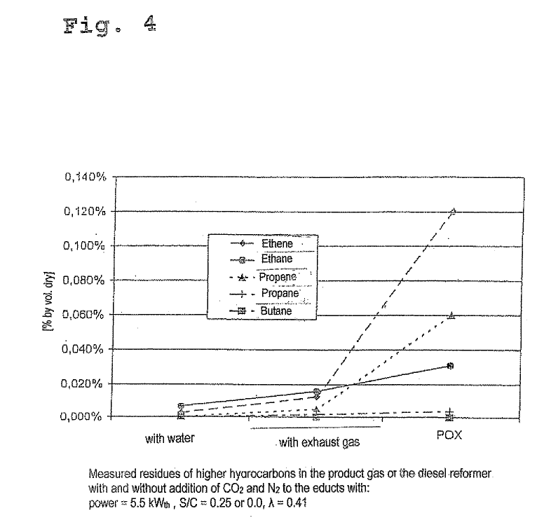

FIG. 4 the proportion in percent by volume of the residues of higher hydrocarbons in the product gas, and also

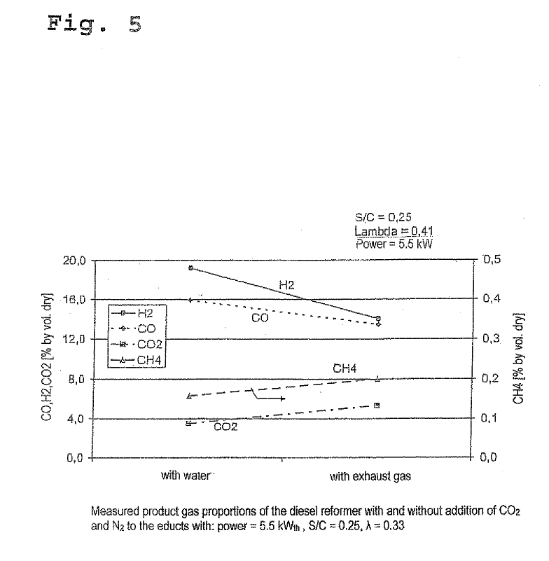

FIG. 5 the product gas proportions of the obtained gases with reference to an embodiment,

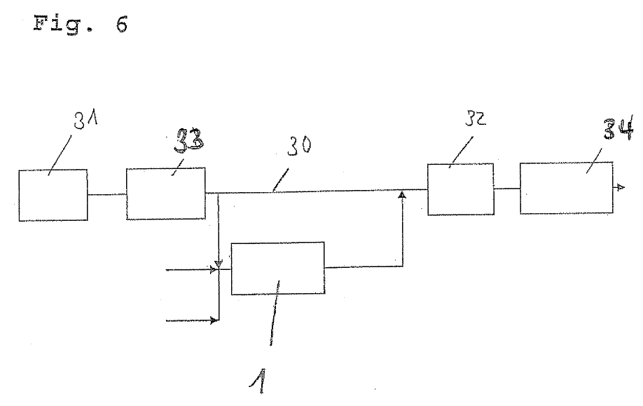

FIG. 6 a further flow diagram of a preferred method.

FIG. 1 shows a reactor 1 for reforming hydrocarbons 15 in the form of a liquid mixture. The reactor 1 has a supply pipe 2 for the educt. In addition, a first mixing stage 3 for the inflow pipe of an O₂-containing mixture and mixing with the educt 15 is provided. Hereafter, a second mixing stage 4 for the inflow of a mixture containing O₂ and also H₂O, N₂ and CO₂ and also a reactor chamber S which is subsequent to the second mixing stage for catalytic oxidation of the mixture obtained in the second mixing stage is provided. The second mixing stage 4 hereby forms the chamber shown essentially in the truncated cone section in FIG. 1 and is therefore located at the upper end of the reactor chamber. Finally, an outlet 6 which serves for discharge of the reaction products is disposed subsequent to the reactor chamber.

The embodiment shown in FIG. 1 shows in detail a supply pipe 2 for the educt 15 in the arrow direction (see FIG. 1), the supply pipe being configured as a tubular inflow pipe with a diameter of 6 mm. The latter has at least one lateral opening 7 through which for example ambient air can be introduced. The result consequently is mixing of educt and ambient air in the first premixing stage which is formed therefore essentially by the tubular inflow pipe. At the end of the first premixing stage a nozzle 8 is hereby provided, which is sealed with heat-resistant copper seals. It can therefore be said that for example the educt, such as for example diesel, can be sprayed into the reactor through the “two-fluid” nozzle shown here.

Around the second premixing stage 4 (the second mixing stage may be assumed merely to be in the interior of the upper section above the reaction chamber), an inflow pipe for the (second) gas mixture which contains O₂ and also H₂O, N₂ and CO₂ is provided in the form of a circumferential chamber. The latter is preferably configured as an annular chamber 9, this annular chamber having mixing nozzles 10, preferably radially distributed towards the second mixing stage 4 (belt of ports). The supply of the mixture containing O₂ and also H₂O, N₂ and CO₂ is hereby effected by means of a tangential supply pipe 11 which enables uniform distribution of the sprayed-in gas mixture over the circumference of the annular chamber 9.

The reactor chamber 5 or the second mixing stage 4 are hereby surrounded by a ceramic pipe 12 so that a radial temperature distribution and as continuous a process temperature as possible is produced here. The reactor chamber is hereby constructed in two shells, around the ceramic pipe 12 a further (pressure-tight) shell made of a stainless noble steel is provided so that the reaction chamber 5 is in total pressure-tight.

At the lower end of the reaction chamber, a catalyst 14 is provided which is configured preferably as a noble metal catalyst on a metallic or ceramic carrier.

Subsequently, an outlet 6 is provided for gas purification and/or a direct access to a fuel cell arrangement.

Now that the basic construction of the reactor has been explained, the implementation of the method according to the invention is dealt with subsequently.

This is a method for reforming a liquid mixture which contains hydrocarbon compounds.

The educt 15 is hereby firstly mixed with a first O₂-containing gas mixture in the first stage 3, the O₂-containing gas mixture currently being ambient air which is introduced through the lateral opening 7. The mixture obtained in the first stage is subsequently mixed in the second premixing stage 4 with a gas mixture containing O₂ and also H₂O, N₂ and CO₂ (currently ambient air which is introduced via a belt of ports and mixed with water vapour) and subsequently the mixture obtained in the second mixing stage 4 is preferably reformed catalytically.

Preferably, the educt 15 is diesel fuel. Currently, the educt is introduced before the mixing in the first stage 3 at a temperature of 50° C. at a low pressure. The temperature of the gas mixture supplied via the lateral opening 7 (currently ambient air) is hereby 200° C. (ambient temperature). Currently, the ratio between the educt 15 and the ambient air, expressed by the air ratio “lambda”, is preferably 0.33. (The air ratio “lambda” is the actually supplied oxygen quantity divided by the oxygen quantity which is required for total oxidation). The gas mixture comprising ambient air and H₂O, N₂ and CO₂ which is supplied in the second mixing stage 4 is introduced at 400° C. so that a temperature of approx. 300° C. is produced in this region after the mixing. The second gas mixture hereby flows through the belt of ports into the second mixing stage (reactor top) and there evaporates the droplet like diesel. Subsequently, the thus produced mixture flows further into the catalyst which currently sits in the reactor 150 mm below the nozzle 8 (relative to the catalyst upper edge).

The ratio of educt 15 to the second gas mixture containing O₂ and H₂O, N₂ and CO₂ is preferably 0.25, expressed by the S/C ratio (=material quantity of water vapour in the supplied gas mixture/material quantity of carbon atoms in the fuel educt). It is particularly advantageous to operate the method with low S/C ratios of for example 0.2. In total, the preferably catalytic treatment is effected by the catalyst 14 at temperatures of for example constantly 1000° C.

The cladding of the reactor chamber 5 with the ceramic pipe 12 hereby avoids heat losses to the environment through the walls of the reactor. Keeping these losses small also has the effect, in addition to reasons of energy, that the radial temperature difference in the catalyst is kept low. It is important that no cooling of the catalyst at the edge layers results, otherwise carbon black is produced there.

The reactor inner wall should therefore comprise a material which is not damaged by temperatures above the process temperature of 1000° C. The design of the reactor thereby presupposed a temperature of 1300° C. A further property which the material of the reactor must fulfil is the chemical inertness with respect to the hydrocarbon oxidation. For example steel containers can hereby assist catalytically undesired reactions as wall material, for which reason the current ceramic inner cladding is sensible.

FIG. 2 now shows a flow diagram of the method according to the invention. The diagram represented in FIG. 2 shows the simple and economical construction of the method according to the invention. In the case of the example according to FIG. 2, diesel 15 is thereby used as hydrocarbon mixture. Air is used for the first premixing stage 3 and is introduced into the two-fluid nozzle 20 via a corresponding valve in the reactor 1. As gas mixture for the second premixing stage 4, air and diesel are thereby provided, said diesel being combusted via an additional burner 26 so that a corresponding exhaust gas containing CO₂, H₂O and N₂ is produced. In the embodiment according to FIG. 2, the method according to the invention directly involves a fuel cell 25.

As fuel cell, all fuel cells known per se in the state of the art can be used here, i.e. for example SOFC and also MCFC fuel cells.

The advantage of the method according to the invention resides in particular in the fact that the gas which emerges from the reactor now need no longer be treated subsequently in any way but can be used directly for the corresponding fuel cells. Furthermore, it should be emphasised that during evaporation of the educt, diesel is produced here in the evaporation chamber without flame formation and liquid residues. As a result of the fact that no liquid water is required, the process can be implemented simply and economically with respect to processing technology and the weight of the entire plant can be kept low.

FIG. 3 now shows the proportions of higher hydrocarbons which are produced with the additional addition of CO₂ and nitrogen to water vapour in the product gas.

In the case of the measuring results represented in FIG. 3, a theoretical composition of a combustion exhaust gas comprising water vapour, CO₂ and N₂ was mixed with a proportion of 13% by volume CO₂, 13% by volume water and 74% by volume nitrogen. In order to achieve a process with higher quality for a fuel cell based on the addition of water by means of exhaust gas, the operation took place with a low S/C=0.25. Consequently, the dilution with CO₂ and N₂ can be reduced. In addition, the chamber speed is halved. Furthermore, the fact is used that the temperature at the catalyst in the second premixing stage drops as a result of the addition of CO₂ and N₂. Lambda could therefore be increased to 0.14 and the maximum temperature could be kept nevertheless below 1000° C. The positive effect of the air ratio increase on the higher hydrocarbons could be established in tests (see FIG. 3). In the case of additional CO₂ and N₂ addition with otherwise identical settings, more higher hydrocarbons, in comparison (FIG. 4), are found in the product gas than in the case of pure water addition. The sum of the proportions of the higher hydrocarbons is however significantly below 0.1% by volume. The concentrations of higher hydrocarbons are therefore so small that there is still no danger of formation of carbon black. In FIG. 4, for comparison, also values of the concentration of higher hydrocarbons in the product gas of a partial oxidation (POX) are indicated, in the case of otherwise identical conditions. The clear advantage of the method according to the invention is shown.

By using the gas mixture according to the invention in the second premixing stage in the form of a gas mixture comprising water, CO₂ and nitrogen, dilution of the product gas takes place. However this leads only insignificantly to a reduction in the concentration of the usable gases (see FIG. 5). Apart from residues of methane, the composition corresponds to thermodynamic equilibrium.

FIG. 6 shows a further flow diagram for a preferred method.

FIG. 6 shows an example in which the reactor 1 according to the invention is disposed in the bypass to a pipe 30 which leads from an internal combustion engine 31 to a device for selective catalytic reduction of nitrogen oxides 32 (SCR device). The flow diagram according to FIG. 6 hence shows the application case in which the reactor according to the invention is used such that the obtained product gases comprising CO and H₂ are used for the reduction of the nitrogen oxides in an internal combustion engine with diesel fuel. It is favourable for this purpose if, as already explained above, the reactor is connected in the bypass, i.e. is subjected only to a partial flow of the exhaust gas from the internal combustion engine 31. Furthermore, it has proved to be favourable if a carbon black filter 33 is situated intermediately again in the exhaust gas pipe 30 for gas purification. It has now been shown that in particular this arrangement is outstandingly suitable for exhaust gas purification of diesel fuels. In the case of the method according to the invention and the corresponding arrangement, as represented in FIG. 6, a diesel oxidation catalyst 34 for reduction of residue CO and hydrocarbons can then also be connected of course subsequently after the device for catalytic reduction of the nitrogen oxides.

1. Method for reforming diesel fuel into H₂ and CO or a product gas containing H₂ and CO:
a) the diesel fuel being mixed in a first premixing stage with an O₂-containing gas mixture and subsequently
b) the thus obtained mixture being mixed in a second premixing stage with an O₂-containing gas mixture and also with an exhaust gas mixture comprising a hydrocarbon combustion containing an H₂O, N₂ and CO₂ gas mixture and subsequently
c) this mixture being subjected to a hydrocarbon oxidation in a reactor with a catalyst.

2. Method according to claim 1,
characterised in that the exhaust gas mixture (method step b) is an exhaust gas mixture comprising a combustion of diesel fuel.

3. Method according to claim 1,
characterised in that the exhaust gas mixture (method step b) contains 10 to 15% by volume CO₂, 10 to 13% by volume water, 0 to 5% by volume O₂ and 73 to 75% by volume N₂.

4. Method according to claim 1, characterised in that the O₂ provided for the second premixing stage is supplied in the form of air, preferably ambient air.

5. Method according to claim 1, characterised in that the diesel fuel, before mixing in the first stage, has a supply temperature of 10 to 70° C., preferably 40 to 60° C.

6. Method according to claim 1, characterised in that the O₂-containing gas mixture provided for the first premixing stage is air, preferably ambient air.

7. Method according to claim 1, characterised in that the temperature of the O₂-containing gas mixture of the first premixing stage is 0 to 50° C., preferably 15 to 25° C.

8. Method according to claim 1, characterised in that the temperature of the exhaust gas mixture, containing O₂ and H₂O and also N₂ and CO₂, of the second premixing stage is 350 to 600° C., preferably 400 to 500° C.

9. Method according to claim 1, characterised in that the hydrocarbon oxidation in the reactor is implemented at 850 to 1000° C. and 0 to 10 bar excess pressure.

10. Method according to claim 1, characterised in that the ratio between the diesel fuel to the O₂-containing gas mixture provided for the first premixing stage is defined by the air ratio lambda (=actually supplied oxygen quantity/oxygen quantity which is required for total oxidation), this being between 0.28 and 0.43, preferably between 0.31 and 0.41.

11. Method according to claim 1, characterised in that the ratio of the diesel fuel to the exhaust gas mixture containing O₂ and H₂O, CO₂ and N₂ and provided for the second premixing stage is indicated by an S/C ratio (=material quantity of water vapour in the supplied gas mixture/material quantity of carbon atoms in the diesel fuel), this ratio being between 0.1 and 0.9, preferably between 0.25 and 0.5.

12. Method according to claim 1, characterised in that the ratio s:c (steam to carbon) for both stages is in total 0.1: 0.9, preferably 0.2:0.5.

13. Method according to at claim 1, characterised in that the obtained H₂/CO gas or H₂/CO-containing product gas is supplied to a fuel cell.

14. Method according to claim 1, characterised in that the obtained H₂/CO gas or H₂/CO product gas is used to reduce nitrogen oxides.

15. Reactor (1) for implementing a conversion of diesel fuel according to claim 1, which has
a) a two-fluid nozzle (20) which prescribes a first premixing stage (3) and a second premixing stage (4) and
b) a reactor chamber (5) disposed subsequent to the two-fluid nozzle for oxidation and an
c) outlet (6) which is disposed subsequent to the reactor chamber (5).

16. Reactor according to claim 15,
characterised in that the two-fluid nozzle (20) is a preferably tubular inflow pipe (2).

17. Reactor according to claim 16,
characterised in that the inflow pipe (2) has at least one lateral opening (7) for the gas mixture provided for the first premixing stage.

18. Reactor according to claim 15, characterised in that a nozzle which is orientated towards the second premixing stage (4) is provided at the end of the first premixing stage (3).

19. Reactor according to claim 15, characterised in that, around the second premixing stage (4), the inflow pipe for the gas mixture of the second premixing stage is provided in the form of a circumferential chamber, preferably an annular chamber (9), this circumferential chamber having mixing nozzles (10) which are preferably radially distributed towards the second mixing stage (4).

20. Reactor according to claim 19,
characterised in that the circumferential chamber has a tangential supply pipe (11).

21. Reactor according to claim 15,
characterised in that the reactor chamber (5) is clad with ceramic material (12).

22. Reactor according to claim 15,
characterised in that the reactor chamber (5) is constructed in at least two shells.

23. Reactor according to claim 15,
characterised in that the reactor chamber (5) is retained by at least one flange (13).

24. Reactor according to claim 15,
characterised in that a catalyst, preferably a noble metal catalyst, is provided on a metallic or ceramic carrier on the side of the reactor chamber (5) which is orientated away from the second mixing stage (4).

25. Reactor for implementing a conversion of diesel fuel according to claim 13,
characterised in that the outlet (6) has direct access to a high temperature fuel cell arrangement (HZ).

26. Reactor according to claim 25,
characterised in that the outlet (6) is connected to a gas purification device.

27. Reactor for implementing a conversion of diesel fuel according to claim 14,
characterised in that the reactor is disposed in the region of an automotive engine in the bypass to the exhaust gas flow and in that the outlet (6) has an access to a device for reducing nitrogen oxides (SCR).

28. Reactor according to claim 27,
characterised in that the reactor has a connection to a carbon black filter at the inlet.
